(19) United States
(12) Patent Application Publication
(10) Pub. No.: US 2005/0138232 A1
(43) Pub. Date: Jun. 23, 2005

(54) Memory system control method

(75) Inventors: Sou Tamura, Osaka (JP); Hideo Ishida, Hyogo (JP); Masaki Tatano, Osaka (JP)

Correspondence Address: MCDERMOTT WILL & EMERY LLP, 600 13TH STREET, N.W., WASHINGTON, DC, 20005-3096, US

(73) Assignee: MATSUSHITA ELECTRIC INDUSTRIAL CO., LTD.

(21) Appl. No.: 11/013,887

(22) Filed: Dec. 17, 2004

(30) Foreign Application Priority Data
Dec. 22, 2003 (JP) P2003-424152

(51) Int. Cl. G06F 12/00

(52) U.S. Cl. 710/22; 711/118

(57) ABSTRACT

A memory system control method is a control method in a system which comprises a central processing unit, a cache memory, and a main memory, and has a DMA transfer function to said main memory, wherein when the amount of data transferred to said main memory reaches an arbitrary value, the data in the cache memory corresponding to the address of data in said main memory which have been written by the DMA transfer are purged.

### BACKGROUND OF THE INVENTION

1. Field of the Invention

The present invention relates to a memory address control in a processor system having a DMA controller for performing a DMA control to a cache memory and a main memory, and a main memory.

2. Description of the Related Art

Conventionally, as a method for achieving an improvement in speed of a processor, in order to read a data program or the like from a main memory, there has been commonly used a cache memory system wherein a memory (cache memory) having small memory capacity and capable of high speed access to the main memory is closely arranged to a processor, so that a part of the data program or the like of the main memory is stored in the cache memory to access the data program or the like at high speed.

In such a cache memory system, a part of data in the main memory has been read into the cache memory to control which address of the main memory stores the part of the data read into the cache memory, so that when the processor reads desired data, the desired data can be obtained from the cache memory if the data exists in the cache memory. FIG. 10 shows the relationship between the data in main memory and data in the cache memory. Parts of data in a main memory (a) is stored in a cache memory (b), and a processor unit or dedicated address control means manages which address in the main memory corresponds to the data in the cache memory (b). If such a system is utilized, high speed data access can be achieved compared with a case where the data are read from the main memory. The data stored in the cache memory like this includes data that the processor frequently obtains, for example program data to be frequently executed or the like.

Moreover, as a cache memory, there also exists a system provided with a first cache memory, and a second cache memory having a larger memory capacity and a lower access speed compared with the first cache memory, and this system can be used such that data with the highest access frequency are stored in the first cache memory, and data having a comparatively high access frequency are stored in the second cache memory. There also exists a system further provided with a third cache memory or the liked as well as the first cache memory and the second cache memory.

Moreover, there has been commonly used a Direct Memory Access (hereinafter also referred to as DMA) control which directly transfers data transferred from an external interface to the main memory without passing through the processor. A load of the processor can be reduced by being provided with a DMA controller for performing this control, and performance of the external interface can be improved by enabling a high speed data transfer with external devices.

A cache memory system provided with such a DMA transfer controller is described in a patent literature Japanese laid-Open Patent Application Publication No. 5-307518 or the like, and hereinafter description will be made of its block diagram and operation.

FIG. 8 is a view showing a cache memory system provided with a conventional DMA controller. In FIG. 8, reference numeral 101 represents a CPU (central processing unit, hereinafter also referred to as CPU ) of this system, and a CPU 101 is directly connected to a cache memory 102 and a bus interface buffer 103 via buses. The CPU 101 can access these devices at high speed. In addition, a main memory 104, and an I/O 105 connected to external sources outside the system are connected thereto via the bus interface buffer 103. Moreover, a DMA controller 106 performs a control for transferring data transferred to the main memory 104 via the I/O 105.

When performing a data write operation, the CPU 101 transmits a write command to the cache memory 102 and the bus interface buffer 103, and the data write operation is performed in the cache memory 102 at high speed. On the other hand, a write buffer for latching the write command and write data is integrated in the bus interface buffer 103, and the write data can be written in the main memory 104 according to an access timing to the main memory 104, so that the CPU 101 does not need to adjust the operation with an access speed to the main memory 104, thereby making it possible to achieve high speed operation.

When performing a data read operation, the CPU 101 transmits a read command to the bus interface buffer 103, the command is latched by a read buffer integrated in the bus interface buffer 103, the read command is transmitted to the main memory 104 according to an access timing to the main memory 104, and the data read operation from the main memory 104 is performed. The data read from the main memory 104 is transmitted to the CPU 101 via the read buffer in the bus interface buffer 103.

In addition, when performing a DMA transfer from the I/O 105 to the main memory 104, the DMA controller 106 sends a hold signal for making operation hold to a bus master, such as the CPU 101 and the bus interface buffer 103. In response to this hold signal, the CPU 101 and the bus interface buffer 103 return hold acknowledge signals to the DMA controller 106, so that the DMA controller 106 starts the DMA transfer.

When the DMA transfer is performed, the data of the main memory 104 are rewritten, and an inconsistency between the data of the main memory 104 and the data in the cache memory 102 corresponding to the data in the main memory 104 will be thereby generated. Therefore, the CPU 101 may not access to correct data. In order to solve this problem, the system comprises address control means 107 for controlling an address of the main memory 104 in which the data transferred by the DMA transfer are written, and purge means 108 for purging the data in the cache memory 102 corresponding to the address in the main memory 104 specified by the address control means 107 where the data have been rewritten. Consequently, an inconsistency between the rewritten data in the main memory 104 and the pre-rewritten data in the main memory 104 stored in the cache memory 102 can be prevented.

According to the cache memory system provided with the above DMA transfer function, the inconsistency between the rewritten data in the main memory by the DMA transfer and the pre-rewritten data in the main memory stored in the cache memory can be prevented; thereby making it possible for the CPU to perform the data read operation correctly. However, in such a conventional method, even when there has been no data read request from the CPU, a purge of the corresponding the data in the cache memory in a certain constant unit has been performed to the rewritten data of the main memory by the DMA transfer at every DMA transfer. For example, if a DMA transfer data unit is one byte (8 bits), half word (16 bits), and one half word (32 bits), a purge process will be performed whenever one byte, half word, and one word are transferred, respectively.

In the cache memory system having the DMA transfer function in FIG. 8, a process flow of the DMA transfer start through its end is shown in FIG. 9 in the case where the DMA transfer data unit is one byte. When a DMA transfer request is generated, the DMA controller 106 holds the operation of the CPU 101 and the bus interface buffer 103, and initiates a DMA transfer control (S901) as described above. The DMA controller controls the I/O 105 and the main memory 104 to store the transferred data in the main memory 104 (S902) via the I/O 105. When the data transferred to the main memory 104 reach one byte which is the DMA transfer unit (S905), the data in the cache memory 102 corresponding to the address in the main memory 104 where the data have been rewritten by the DMA transfer are purged by the address control means 107 and the purge means 108 (S906). When all data that are to be transferred by the DMA transfer are completely transferred to the main memory 104 (S903) between the processes S905 through S902, the DMA transfer process is completed (S907). Also when the read command is generated from the CPU 101 during the DMA transfer process (S904), the DMA controller 106 interrupts the DMA transfer operation (S907). On the other hand, when the data transfer by the DMA transfer has not been completed, and there is no read request from the CPU 101 or the like, the DMA transfer from the I/O 105 to the main memory 104 is continued, and the processes S902 through S906 are performed.

In the conventional processes described above, since the purge of the cache memory is performed whenever the data of the DMA transfer data unit are written in the main memory, deterioration of process efficiency of the DMA controller is caused, so that a problem of increase in processing man-hour or processing time may arise.

### SUMMARY OF THE INVENTION

In the light of above problems, an object of the present invention is to further improve process efficiency in a cache memory system having a DMA transfer function, and to thereby reduce processing man-hour and processing time. In the present invention, a purge process of corresponding data in a cache memory is not performed whenever data of a DMA transfer data unit are transferred to a main memory; but the purge process of the corresponding the data in the cache memory is performed when the amount of data which is transferred by the DMA transfer and written in the main memory reaches an arbitrary amount of data, or when the data transferred by the DMA transfer reach a writable capacity of the main memory.

Alternatively, a method is provided which switches whether the data in the cache memory are purged according to a size of data transferred to the main memory by the DMA transfer, and a CPU performs a data access to the data transferred by the DMA transfer using the cache memory; or without purging the data in the cache memory, the CPU performs the data access only to the main memory for the data transferred by the DMA transfer without using the cache memory. If the data transferred by the DMA transfer is not more than a certain size of date, even when the data access is performed only to the main memory without using the cache memory, that does not make process efficiency deteriorate as the system, so that the purge process of the cache memory can be reduced, thereby making it possible to improve process efficiency of the system.

### BRIEF DESCRIPTION OF THE DRAWINGS

FIG. 1 is a block diagram of a cache memory system having a DMA transfer function according to the present invention;

FIG. 2 is a flow chart 1 showing a control method according to the present invention;

FIG. 3 is a flow chart 2 showing a control method related to the present invention;

FIG. 4 is a flow chart 3 showing a control method according to the present invention;

FIG. 5 is an address state diagram 1 in a main memory;

FIG. 6 is an address state diagram 2 in the main memory;

FIG. 7 is an address state diagram 3 in the main memory;

FIG. 8 is a block diagram of a cache memory system having a conventional DMA transfer function;

FIG. 9 is a flow chart showing a conventional memory control method;

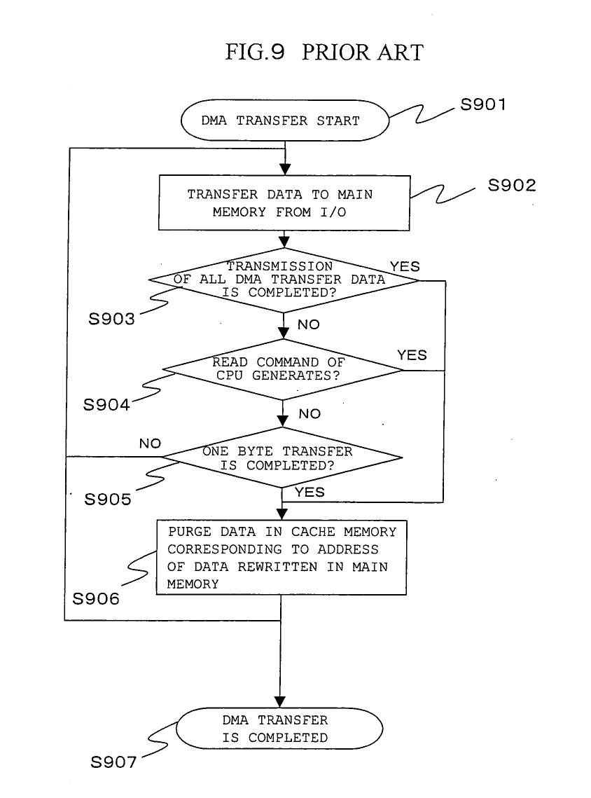

FIG. 10 is a view of a relationship between data in the main memory and data in the cache memory; and

FIG. 11 is a schematic block diagram of a digital broadcasting receiver.

### DETAILED DESCRIPTION OF THE PREFERRED EMBODIMENTS

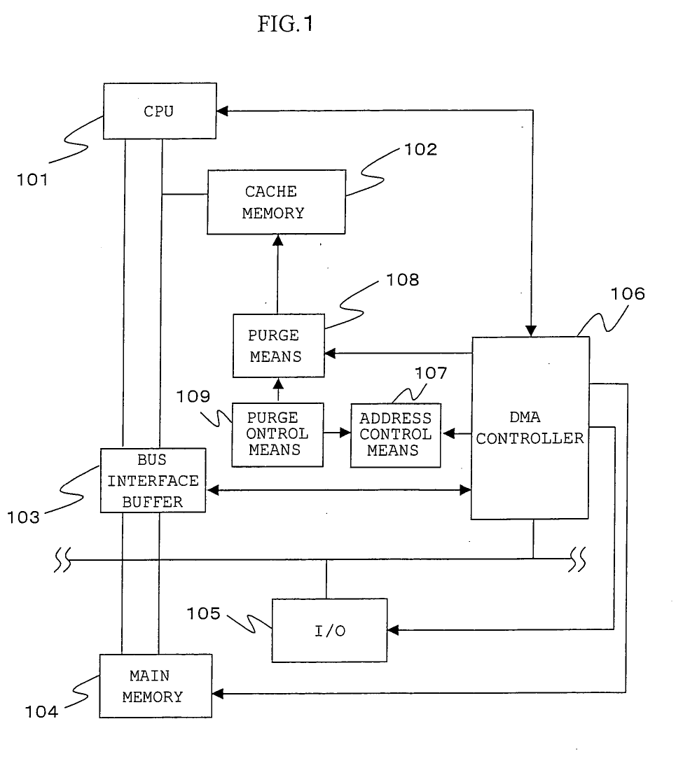

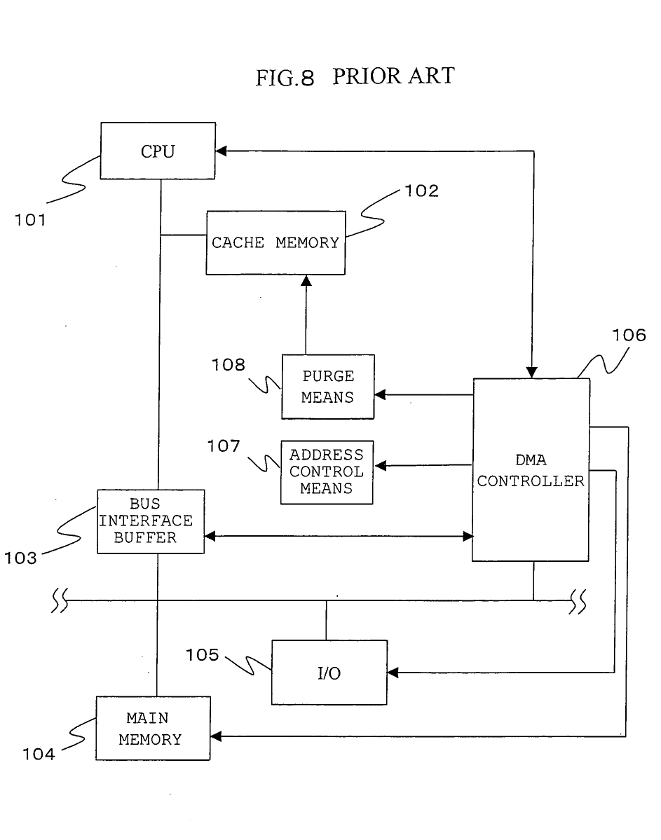

The present invention is characterized by further comprising a purge control means of switching the timing or the like for purging data in the cache memory corresponding to data in the main memory rewritten by a DMA transfer, by means of further controlling purge means in a cache memory system shown in FIG. 8 as a conventional art. FIG. 1 shows a cache memory system having the purge control means. In FIG. 1, the same reference numeral is given to a component which has a function similar to that of FIG. 8. In this cache memory system, the purge control means controls the purge means based on address information that address control means has. The address control means to which a data address or the like in the main memory rewritten by the DMA transfer from the DMA controller is sent performs an address control of the data in the main memory. Hereinafter, description will be made in each embodiment of a control of a cache memory system shown in FIG. 1, including a control method that the purge control means performs.

### First Embodiment

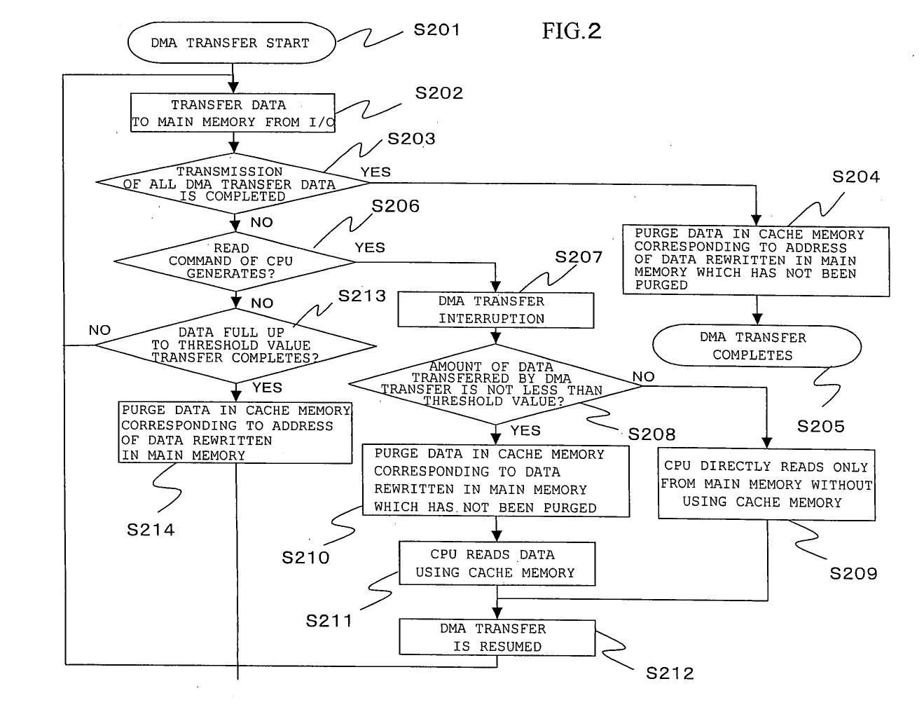

FIG. 2 shows a rough outline of a control method according to a first embodiment of the present invention, and is a flow chart showing processing contents from a DMA transfer start to a DMA transfer completion. Hereinafter, description will be made of its operation.

First, when a DMA transfer request is initiated, the DMA controller 106 sends a hold signal for making operation hold to a bus master, such as a CPU 101 and the bus interface buffer 103. In response to this hold signal, the CPU 101 and the bus interface buffer 103 return hold acknowledge signals to the DMA controller 106, so that the DMA controller 106 starts the DMA transfer (S201). The DMA controller 106 transfers the data which is transferred to the main memory via the I/O 105 to write the data in the main memory (S202). In the meantime, when all transfer data by the DMA transfer have been completely transferred (S203), the DMA controller controls the purge means to perform the purge of the data in the cache memory 102 which have not been purged corresponding to the data in the main memory 104 rewritten by the DMA transfer (S204). The DMA controller 106 then completes the DMA transfer and notifies the CPU 101 and the bus interface buffer 103 on the DMA transfer completion (S205). Incidentally, a purge process of the data in the cache memory 102 at S204 may not be performed in this phase; and it may also be possible to purge the data in the cache memory 102 when a data access from the CPU 101 is generated after the DMA transfer completion at S205.

When the DMA transfer is continued (S203) and a data access command from the CPU 101 is generated in the meantime (S206), the CPU 101 notifies the hold signal to the DMA controller 106, and the DMA controller 106 interrupts the DMA transfer according to the hold signal. Incidentally, for the interruption of this CPU 101, it may be also possible for the DMA controller 106 not to approve the interruption of the CPU 101 without interrupting the DMA transfer. A process having a higher priority may be performed on a priority basis according to a priority between a read process of the CPU 101 and a DMA transfer process. When the DMA transfer is interrupted, a comparison with a threshold value set to the purge control means 109 is performed (S208), and if the amount of rewritten data is not more than the threshold value, the CPU 101 will not perform the data access using the cache memory 102, but perform the data access only to the main memory 104 (S209). If the amount of rewritten data is not less than the threshold value, the data in the cache memory 102 which have not been purged corresponding to the data in the main memory 104 rewritten by the DMA transfer (S210) are purged. Incidentally, the purge process of S210 may be a process which purges only the data in the cache memory 102 corresponding to an address of the data in the main memory that the CPU 101. When the purge of the data in the cache memory 102 is performed, the CPU 101 performs the data access to the main memory 104 using the cache memory 102 (S211) . According to a comparison result between this set threshold value and the amount of write data to the main memory 104 by the DMA transfer, the CPU 101 switches whether or not to access using the cache memory 102, thereby making it possible to reduce the number of processes as the system. In other words, if the amount of data transferred by the DMA transfer is not large, it consequently makes a processing speed faster to perform the data access only to the main memory 104 without performing the purge of the data in the cache memory 102 on purpose. This threshold value can be changed into an optimum value automatically or by a user according to an application of the system in which this cache memory 102 is used, the capacity of the main memory 104, the amount of data transferred by the DMA transfer, and a data access frequency of the CPU 101 or the like, or can be determined at a design phase or the like. When the CPU 101 completes the data access at S310 or S311, the CPU notifies a hold release signal to the DMA controller 106, and the DMA controller 106 starts a DMA transfer control again (S212).

When the DMA transfer is continued (S203), although the address control means 107 continuously updates addresses of the data written in the main memory 104 by the DMA transfer, the purge control means 109 has set an arbitrary threshold value to the amount of the data written in this main memory. When the data written in the main memory 104 by the DMA transfer becomes not less than this arbitrary threshold value (S211), the purge control means 109 purges the data in the cache memory 102 corresponding to the rewritten data in the main memory 104 each time (S212). This threshold value can be changed into an optimum value automatically or by a user according to an application of the system in which this cache memory 102 is used, the capacity of the main memory 104, the amount of data transferred by the DMA transfer, and the data access frequency of the CPU 101 or the like, or can be determined at a design phase or the like. In addition, this threshold value can be set as a full capacity of a recordable remaining area in the main memory 104, thereby making it possible to reduce to a maximum the number of processes of the purge process in the cache memory 102 in this case. In addition, since the recordable area of the main memory 104 is changed when a read operation or the like from the CPU 101 is generated, it is possible to change it again whenever the read operation from the CPU 101 is generated.

Incidentally, with regard to the purge process of the data in the cache memory 102, if the data corresponding to the data in the main memory 104 rewritten by the DMA transfer do not exist in the cache memory 102, it is also possible to perform a switching control by the purge control means 109 so that the purge process may not be performed.

In addition, the DMA transfer process controlled by the DMA controller 106 and the memory access process by the CPU 101 are not necessarily exclusive relationship, but in a system which can simultaneously perform the DMA transfer to the main memory 104 from the I/O 105 and the data access to the main memory 104 from the CPU 101, even when the data access command from the CPU 101 is generated as described in this embodiment, while the DMA controller 106 does not interrupt the DMA transfer but continues the DMA transfer, the CPU 101 can perform the data access to the main memory 104.

In addition, for the data which have been transferred to the main memory 104 by the DMA transfer but already accessed from the CPU 101, and an address in which the data judged to be unnecessary are written, data can be overwritten by the DMA transfer.

According to this embodiment, while the purge process of the data in the cache memory has conventionally been performed for every DMA transfer data unit, the purge process of the data in the cache memory is performed whenever the DMA transfer data to the main memory reach the set threshold value, thereby making it possible to reduce the number of processes of the purge process. For example, in a system where the DMA transfer data unit is one byte, although the data in the cache memory have conventionally been purged per one byte, if the threshold value set by the purge control means in the present invention is ten bytes, the purge process can be reduced to 1/10. In addition, the threshold value is set as a capacity of the recordable area in the main memory, so that it is also possible to effectively utilize the most of the main memory, and reduce the purge process in the cache memory.

Moreover, even when the rewritten data in the main memory by the DMA transfer does not reach the threshold value, the purge process of the data in the cache memory is performed prior to the data access from the CPU, thereby making it possible to thoroughly perform the purge.

### Second Embodiment

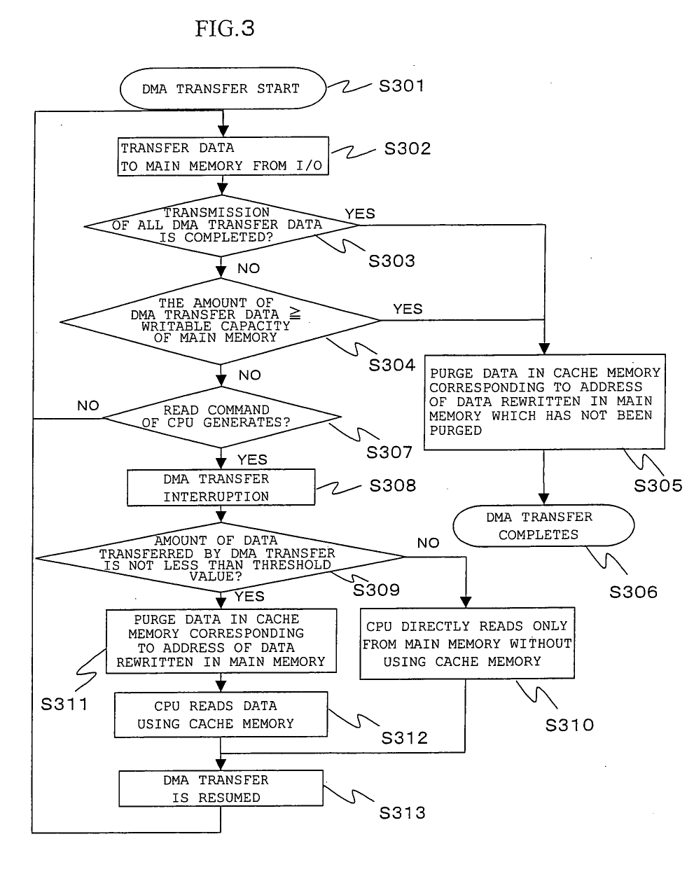

Next, description will be made of a second embodiment of present invention. FIG. 3 is a flow chart showing a rough outline from a DMA transfer start to a DMA transfer completion of a control method according to this embodiment. Hereinafter, description will be made of its operation.

First, when the DMA transfer is initiated, the DMA controller 106 sends the hold signal for making operation hold to the bus master, such as the CPU 101 and the bus interface buffer 103. In response to this hold signal, the CPU 101 and the bus interface buffer 103 return the hold acknowledge signals to the DMA controller 106, so that the DMA controller 106 starts the DMA transfer (S301). The DMA controller 106 transfers the data transferred to the main memory 104 via the I/O 105 to write the data in the main memory 104 (S302). In the meantime, when all transfer data transferred by the DMA transfer have been completely transferred (S303), or when the amount of data transferred to the main memory 104 by the DMA transfer reaches a writable capacity of the main memory 104 (S304), the purge control means 109 controls the purge means 108 to perform the purge of the data in the cache memory 102 which have not been purged corresponding to the data in the main memory 104 rewritten by the DMA transfer (S305). The DMA controller 106 then completes the DMA transfer and notifies the CPU 101 and the bus interface buffer 103 about the completion of the DMA transfer (S306). Incidentally, the purge process of the data in the cache memory 102 at S305 may not be performed in this phase; and it may also be possible to purge the data in the cache memory 102 when the data access from the CPU 101 is generated after the DMA transfer completion at S306. In addition, when the amount of data transferred to the main memory by the DMA transfer reaches the writable capacity of the main memory at S304, the process moves to the DMA transfer completion at S306, and it is also possible to perform a control that the DMA transfer is resumed immediately after the CPU 101 performs the data access to the main memory 104.

When the DMA transfer is continued (S303, S304) and the data access command from the CPU 101 is generated in the meantime (S307), the CPU 101 notifies the hold signal to the DMA controller 106, and the DMA controller 106 interrupts the DMA transfer according to the hold signal. Incidentally, for the interruption of this CPU 101, it may be also possible for the DMA controller 106 not to approve the interruption of the CPU 101 without interrupting the DMA transfer. A process having a higher priority may be performed on a priority basis according to a priority between a read process of the CPU 101 and a DMA transfer process, When the DMA transfer is interrupted, a comparison between the amount of data rewritten in the main memory 104 by the DMA transfer and the threshold value set to the purge control means 109 is performed (S609), and if the amount of rewritten data is not more than the threshold value, the CPU 101 will not perform the data access using the cache memory 102, but perform the data access only to the main memory 104 (S310). If the amount of rewritten data is not less than the threshold value, the CPU 101 purges the data in the cache memory 102 which have not been purged corresponding to the data in the main memory 104 rewritten by the DMA transfer (S311) Incidentally, the purge process at S311 may be a process which purges only the data in the cache memory 102 corresponding to the address of the data in the main memory that the CPU 101. When the purge of the data in the cache memory 102 is performed, the CPU 101 performs the data access to the main memory 104 using the cache memory 102 (S312) . According to a comparison result between this set threshold value and the amount of write data in the main memory 104 by the DMA transfer, the CPU 101 switches whether or not to access using the cache memory 102, thereby making it possible to reduce the number of processes as the system. In other words, if the amount of data by the DMA transfer is not large, it consequently makes the processing speed faster to perform the data access only to the main memory 104 without performing the purge of the data in the cache memory 102. This threshold value can be changed into an optimum value automatically or by a user according to an application of the system in which this cache memory 102 is used, the capacity of the main memory 104, the amount of data transferred by the DMA transfer, and the data access frequency of the CPU 101 or the like, or can be determined at a design phase or the like. When the CPU 101 completes the data access at S310 or S311, the CPU notifies the hold release signal to the DMA controller 106, and the DMA controller 106 starts the DMA transfer control again (S313).

Incidentally, with regard to the purge process of the data in the cache memory 102, if the data corresponding to the data in the main memory 104 rewritten by the DMA transfer do not exist in the cache memory 102, it is also possible to perform a switching control by the purge control means 109 so that the purge process may not be performed.

In addition, the DMA transfer process controlled by the DMA controller 106 and the memory access process by the CPU 101 are not necessarily exclusive relationship, but in a system which can simultaneously perform the DMA transfer to the main memory 104 from the I/O 105 and the data access to the main memory 104 from the CPU 101, even when the data access command from the CPU 101 is generated as described in this embodiment, while the DMA controller 106 does not interrupt the DMA transfer but continues the DMA transfer, the CPU 101 can perform the data access to the main memory 104.

In addition, for the data which have been transferred to the main memory 104 by the DMA transfer but already accessed from the CPU 101, and an address in which the data judged to be unnecessary are written, data can be overwritten by the DMA transfer.

According to this embodiment, while the purge process of the data in the cache memory has conventionally been performed for every DMA transfer data unit, the purge process of the data in the cache memory is performed according to a read request generation from the CPU, thereby making it possible to reduce the number of processes of the purge process. For example, in a system where the DMA transfer data unit is one byte, although the data in the cache memory have conventionally been purged per one byte, if a frequency of the data access generation from the CPU generates is one time in about ten bytes of the amount of data of the DMA transfer while the DMA transfer is performed according to the present invention, the purge process can be reduced to 1/10.

### Third Embodiment

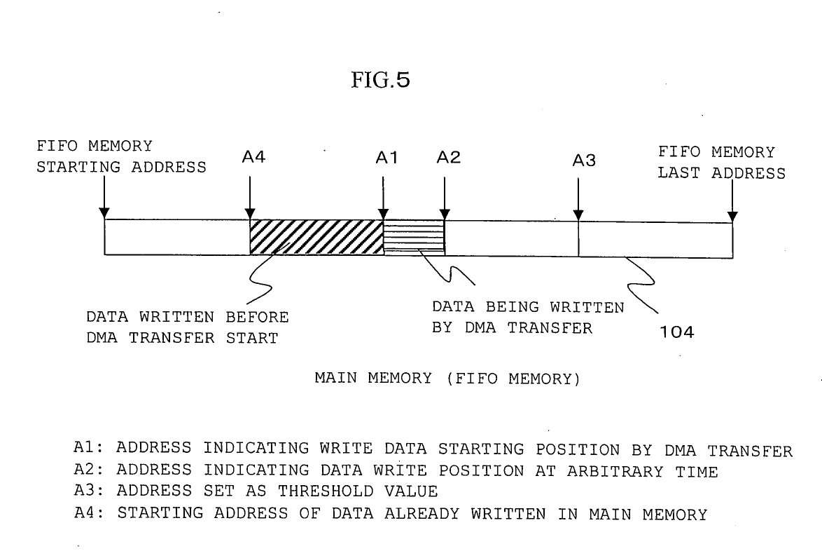

Next, description will be made of a third embodiment of present invention. In this embodiment, a FIFO (First In First Out) memory of a ring buffer is employed as the main memory of the cache memory system in the first embodiment. Hereinafter, the main memory 101 in FIG. 1 is therefore treated as the FIFO memory of the ring buffer in the following. FIG. 5 is a view showing an address state in the main memory 104. In addition, a control method of this embodiment is roughly similar to that of the first embodiment, and description will be made of this embodiment using the flow chart shown in FIG. 2, and FIG. 1 and FIG. 5.

First, the DMA transfer is initiated, the DMA controller 106 sends the hold signal for making operation hold to the bus master, such as the CPU 101 and the bus interface buffer 103. In response to this hold signal, the CPU 101 and the bus interface buffer 103 return the hold acknowledge signals to the DMA controller 106, so that the DMA controller 106 starts the DMA transfer (S201). The DMA controller 106 transfers the data transferred to the main memory 104 via the I/O 105 to write the data in the main memory 104 (S202).

Using FIG. 5, description will be made of a write state of the data in the main memory which is the FIFO memory here. A1 represents an address where the data transferred by the DMA transfer is firstly written in the main memory 104. If the data are not recorded in the main memory 104, it is possible to write from a starting address of the main memory 104 by specifying the starting address of the main memory 104 as the address A1. The data transferred by the DMA transfer are sequentially written in the main memory 104 from the address A1, and A2 is an address representing a write position of the data at an arbitrary time of the data sequentially written. In the FIFO memory, the address A2 closes to a last address of the FIFO memory as the DMA transfer data are written, and when the address A2 reaches this last address, the data write is performed from the starting address of the FIFO memory. Incidentally, an area where the data are written like this must be a writable area, and this writable area can be increased because originally recorded data are read out or the like. Therefore, as described later, when an interruption of data read is performed by the CPU 101 during the DMA transfer, or a data read operation by the CPU 101 is simultaneously performed, the data writable area is increased. These addresses A1 and A2 are controlled by the address control means.

While the data are sequentially written in the main memory 104 like this, when all transfer data by the DMA transfer have been completely transferred (S203), the purge control means 109 controls the purge means 108, to perform the purge of the data in the cache memory 102 which have not been purged corresponding to the data in the main memory 104 rewritten by the DMA transfer (S204) . The DMA controller 106 then completes the DMA transfer and notifies the CPU 101and the bus interface buffer 103 about the completion of the DMA transfer (S205) Incidentally, the purge process of the data in the cache memory 102 at S204 may not be performed in this phase; and it may also be possible to purge the data in the cache memory 102 when the data access from the CPU 101 is generated after the DMA transfer completion at S505.

When the DMA transfer is continued (S203) and the data access command from the CPU 101 is generated in the meantime (S206), the CPU 101 notifies the hold signal to the DMA controller 106, and the DMA controller 106 interrupts the DMA transfer according to the hold signal. Incidentally, for the interruption of this CPU 101, it may be also possible for the DMA controller 106 not to approve the interruption of the CPU 101 without interrupting the DMA transfer. A process having a higher priority may be performed on a priority basis according to a priority between a read process of the CPU 101 and a DMA transfer process, When the DMA transfer is interrupted, a comparison with the threshold value set to the purge control means 109 is performed (S208), and if the amount of rewritten data is not more than the threshold value, the CPU 101 will not perform the data access using the cache memory 102, but perform the data access only to the main memory 104 (S209) If the amount of rewritten data is not less than the threshold value, the CPU 101 purges the data in the cache memory 102 which have not been purged corresponding to the data in the main memory 104 rewritten by the DMA transfer (S210) . Incidentally, the purge process of S210 may be a process which purges only the data in the cache memory 102 corresponding to the address of the data in the main memory that the CPU 101. When the purge of the data in the cache memory 102 is performed, the CPU 101 performs the data access to the main memory 104 using the cache memory 102 (S211) . According to a comparison result between this set threshold value and the amount of write data in the main memory 104 by the DMA transfer, the CPU 101 switches whether or not to access using the cache memory 102, thereby making it possible to reduce the number of processes as the system. In other words, if the amount of data by the DMA transfer is not large, it consequently makes the processing speed faster to perform the data access only to the main memory 104 without performing the purge of the data in the cache memory 102. This threshold value can be changed into an optimum value automatically or by a user according to an application of the system in which this cache memory 102 is used, the capacity of the main memory 104, the amount of data transferred by the DMA transfer, and the data access frequency of the CPU 101 or the like, or can be determined at a design phase or the like. When the CPU 101 completes the data access at S310 or S311, the CPU notifies the hold release signal to the DMA controller 106, and the DMA controller 106 starts the DMA transfer control again (S212).

When the DMA transfer is continued (S203), the address control means 107 continuously updates addresses of the data written in the main memory 104 by the DMA transfer, and the purge control means 109 has set the arbitrary threshold value to the amount of the data written in this main memory 104. When the data written in the main memory 104 by the DMA transfer reach this arbitrary threshold value (S213), the purge control means 109 purges the data in the cache memory 102 corresponding to the rewritten data in the main memory 104 at each time (S214 Description will be made of a setting pattern of this threshold value in detail using FIG. 5. A3 is an address which defines the threshold value set to the purge control means 109. It is judged that the data written in the main memory 104 by the DMA transfer reach the threshold value when the address A2 showing the write position in an arbitrary time reaches the address A3. Description will further be made of how to set the address A3.

First, description will be made of a setting pattern of the address A3 at the time of the DMA transfer start. First, (1) the address A3 may be defined as an arbitrary address between the address A1 which is the write start position to the main memory 104 by the DMA transfer, and the last addresses of the main memory 104. In this case, when the address A2 which is the current write position reaches the address A3, it is judged that the data written in the main memory by the DMA transfer have reached the threshold value. In other words, it is a time given by address A2≧address A3. Next, (2) the address A3 may be defined as the last address of the main memory 104 which is the FIFO memory. In this case, when the address A2 reaches the last address of the main memory 104, it is judged that the data written in the main memory 104 by the DMA transfer have reached the threshold value. In other words, when address A2=last address, or the address A2 reaches the last address and the data is written from the starting address of the main memory, it is a time given by starting address □ address A2 □ address A1. Next, (3) the address A3 may be defined as an arbitrary address between the starting address of the main memory 104 which is the FIFO memory and the address A1. In other words, when the address A2 reaches the last address of the FIFO memory, the DMA transfer data is written from the starting address of the FIFO memory, and in addition to that, the address A2 where the data is written reach the address A3, namely when it becomes address A2≧address A3 after the address A2 has reached the last address of the FIFO memory, it is judged that the data written in the main memory 104 by the DMA transfer have reached the threshold value. Next, (4) the address A3 may be defined as the address A1 which is the position where the write operation is initiated by the DMA transfer. In other words, when the address A2 reaches the last address of the FIFO memory, the DMA transfer data is written from the starting address of the FIFO memory, and in addition to that, the address A2 where the data is written reaches the address A1, namely, when address A2≧address A1 after the address A2 has reached the last address of the FIFO memory, it is judged that the data written in the main memory 104 by the DMA transfer have reached the threshold value.

Incidentally, each setting pattern of the address A3 described above has limitation, so that the address A3 cannot be set in an area where the data read operation has not been performed yet. The address A3 determined for the threshold value setting therefore changes based on memory availabilities according to that time. In addition, if the memory is used most effectively, the address A3 is preferably set so as to specify a whole data recordable area. In FIG. 5, A4 represents the starting address of the data which have not been read yet, and the data which have not been read yet may exist in an area from the address A4 to the address A1 in this case. An area from the address A1 to the last address of the main memory, and an area from the starting address of the main memory 104 to the address A4 are therefore in a state where the data can be written. In other words, the address A3 can be set in these areas, so that the memory can be used most effectively, if it is set as address A3=address A4, thereby making it possible to reduce the data purge process in the cache memory 102. In addition, when the data access to the main memory 104 by the CPU 101 is performed, the writable areas are increased in the main memory 104 by the accessed data, and the address A4 is updated, so that the address A3 is also preferably reset at this time.

Incidentally, the address A3 may not be necessarily needed to be made the same as the address A4 as mentioned above, but can be changed into an optimum value automatically or by a user according to an application of the system in which this cache memory 102 is used, the capacity of the main memory 104, the amount of data transferred by the DMA transfer, and the data access frequency of the CPU 101 or the like, or can be determined at a design phase or the like.

Incidentally, the purge control means 109 performs each setting mentioned above based on an address in the main memory 104 that the address control means 107 controls, and makes the purge means 108 perform the purge process of the data in the cache memory 102 as needed.

Incidentally, with regard to the purge process of the data in the cache memory 102, if the data corresponding to the data in the main memory 104 rewritten by the DMA transfer do not exist in the cache memory 102, it is also possible to perform a switching control by the purge control means 109 so that the purge process may not be performed.

In addition, the DMA transfer process controlled by the DMA controller 106 and the memory access process by the CPU 101 are not necessarily exclusive relationship, but in a system which can simultaneously perform the DMA transfer to the main memory 104 from the I/O 105 and the data access to the main memory 104 from the CPU 101, even when the data access command from the CPU 101 is generated as described in this embodiment, while the DMA controller 106 does not interrupt the DMA transfer but continues the DMA transfer, the CPU 101 can perform the data access to the main memory 104.

According to this embodiment, while the purge process of the data in the cache memory has conventionally been performed for every DMA transfer data unit, the purge process of the data in the cache memory is performed whenever the DMA transfer data to the main memory reach the set threshold value, thereby making it possible to reduce the number of processes of the purge process. For example, in a system where the DMA transfer data unit is one byte, although the data in the cache memory have conventionally been purged per one byte, if the threshold value set by the purge control means is ten bytes in the present invention, the purge process can be reduced to 1/10. In addition, the area where the data are written can be controlled with ease by making the most of the characteristics of the FIFO memory, and the threshold value setting may also be set with ease according to the data writable area in the memory, so that it is also possible to simplify the process for the threshold value setting.

In addition, even when the rewritten data in the main memory by the DMA transfer does not reach the threshold value, the purge process of the data in the cache memory is performed prior to the data access from the CPU, thereby making it possible to thoroughly perform the purge.

### The Fourth Embodiment

Next, description will be made of a fourth embodiment of present invention. In this embodiment, a FIFO (First In First Out) memory of a ring buffer is employed as the main memory of the cache memory system in the second embodiment. Hereinafter, the main memory in FIG. 1 is therefore treated as the FIFO memory of the ring buffer in the following. FIG. 5 is the FIFO memory representing the main memory. Moreover, a control method of this embodiment is roughly similar to that of the second embodiment, description will be made of this embodiment using the flow chart shown in FIG. 3, and FIG. 1 and FIG. 5.

First, the DMA transfer is initiated, the DMA controller 106 sends the hold signal for making operation hold to the bus master, such as the CPU 101 and the bus interface buffer 103. In response to this hold signal, the CPU 101 and the bus interface buffer 103 return the hold acknowledge signals to the DMA controller 106, so that the DMA controller 106 starts the DMA transfer (S301). The DMA controller 106 transfers the data transferred to the main memory 104 via the I/O. 105 to write the data in the main memory 104 (S302).

Here, a write state of the data in the main memory 104 which is the FIFO memory is similar to that described in the third embodiment, and the state is shown in FIG. 5. The write operation of the data transferred by the DMA transfer is started from the address A1 in the main memory 104, the address A2 representing the write position which changes closes to the last address in the main memory 104 as the data write proceeds, and when the address A2 which is the write position reaches the last address, the data is written from the starting address in the main memory 104. As the data write further proceeds, the address A2 closes to the address A1 where the data write is started. Incidentally, as also described in the third embodiment, when the data which have not been read yet exist in the main memory 104, the write operation may not be performed to an area where the data is recorded, so that the write operation is not performed until the read operation. For example, when the data are written in an area between the address A1 and the address A4 as shown in FIG. 5 when the DMA transfer starts, the area where the data are written by the DMA transfer are an area from the address A1 to the last address of the main memory 104, and an area from the starting address of the main memory 104 to the address A4. Incidentally, as described later, when the interruption of the data read from the CPU 101 is performed, or the data read from the CPU 101 is simultaneously performed during the DMA transfer, the address A4 is updated.

While the data transferred by the DMA transfer is sequentially written in the main memory 104 like this, when all transfer data transferred by the DMA transfer have been completely transferred (S303), or when the amount of data transferred to the main memory 104 by the DMA transfer reaches the writable capacity of the main memory 104 (S304), the purge control means 109 controls the purge means 108, to perform the purge of the data in the cache memory 102 which have not been purged corresponding to the data in the main memory 104 rewritten by the DMA transfer (S604). The DMA controller 106 then completes the DMA transfer and notifies the CPU 101 and the bus interface buffer 103 about the completion of the DMA transfer (S306) . Incidentally, the purge process of the data in the cache memory 102 at S305 may not be performed in this phase; and it may also be possible to purge the data in the cache memory 102 when the data access from the CPU 101 is generated after the DMA transfer completion at S306. In addition, when the amount of data transferred to the main memory 104 by the DMA transfer reaches the writable capacity of the main memory 104 at S304, the process moves to the DMA transfer completion at S306, and it is also possible to perform a control that the DMA transfer is resumed immediately after the CPU 101 performs the data access to the main memory 104.

Herein, description will be made of a process which judges that the amount of data transferred to the main memory 104 at S304 reaches the writable capacity of the main memory 104 in the following. This process is a process, namely, to determine that the data write in the main memory 104 can not be performed since all data transferred by the DMA transfer have been written in the recordable area of the main memory 104. Description will be made in detail of determination means of detecting that the data write in the main memory 104 can not be performed any more.

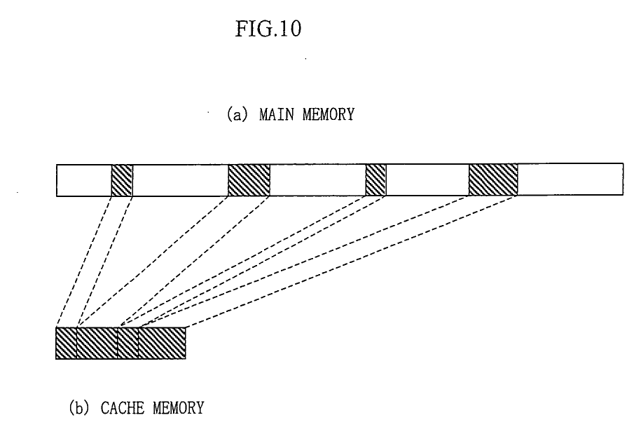

Hereafter, referring to FIG. 10, description will be made of a process where the data are written in the main memory 104 by the DMA transfer through a process where the data write to the main memory 104 can not be performed. First, in a state where the data which have not been read exist in an area from the address A4 to the address A1 of the main memory 104 which is the FIFO memory, the DMA transfer is initiated, and the data write from the address A1 in the main memory 104 is started. As the data are written, the address A2 representing the data write position in the main memory 104 reaches the last address of the main memory 104. That the address A2 reaches the last address of the main memory 104 means that the data transferred by the DMA transfer have been written in the area of the address A1 through the last address in the main memory 104, so that the write operation of the data transferred by the DMA transfer is started from the starting address in the main memory 104. In other words, when reaching the last address of the main memory 104, the address A2 moves to the starting address of the main memory 104, and closes to the address A4. When the DMA transfer proceeds and the address A2 reaches the address A4, it is judged that the amount of data transferred to the main memory 104 has reached the writable capacity of the main memory 104. These addresses A1, A2, and A4 are notified by the DMA controller 106 for controlling the DMA transfer, and are controlled by the address control means 107. Moreover, as detection methods for the address A2 to reach the address A4, there is a method of detecting that address A2=address A4 by the purge control means 109, or detecting that a difference between the address A1 where data write in the main memory 104 is started by the DMA transfer and the address A2 is coincident with the amount of data currently written in the main memory 104 before the DMA transfer starts. Incidentally, when the CPU 101 requests the access to the main memory and the data in the main memory 104 are read, the address A4 is changed, and description will be made of its point in the following.

When the DMA transfer is continued (S303, S304) and the data access command from the CPU 101 is generated in the meantime (S307), the CPU 101 notifies the hold signal to the DMA controller 106, and the DMA controller 106 interrupts the DMA transfer according to the hold signal. Incidentally, for the interruption of this CPU 101, it may be also possible for the DMA controller 106 not to approve the interruption of the CPU 101 without interrupting the DMA transfer. A process having a higher priority may be performed on a priority basis according to a priority between a read process of the CPU 101 and a DMA transfer process, When the DMA transfer is interrupted, a comparison between the amount of data rewritten in the main memory 104 by the DMA transfer and the threshold value set to the purge control means 109 is performed (S309), and if the amount of rewritten data is not more than the threshold value, the CPU 101 will not perform the data access using the cache memory 102, but perform the data access only to the main memory 104 (S310). If the amount of rewritten data is not less than the threshold value, the CPU 101 purges the data in the cache memory 102 which have not been purged corresponding to the data in the main memory 104 rewritten by the DMA transfer (S311) Incidentally, the purge process at S210 may be a process which purges only the data in the cache memory 102 corresponding to the address of the data in the main memory that the CPU 101 reads. When the purge of the data in the cache memory 102 is performed, the CPU 101 performs the data access to the main memory 104 using the cache memory 102 (S312). According to a comparison result between this set threshold value and the amount of write data in the main memory 104 by the DMA transfer, the CPU 101 switches whether or not to access using the cache memory 102, thereby making it possible to reduce the number of processes as the system. In other words, if the amount of data by the DMA transfer is not large, it consequently makes the processing speed faster to perform the data access only to the main memory 104 without performing the purge of the data in the cache memory 102. This threshold value can be changed into an optimum value automatically or by a user according to an application of the system in which this cache memory 102 is used, the capacity of the main memory 104, the amount of data transferred by the DMA transfer, and the data access frequency of the CPU 101 or the like, or can be determined at a design phase or the like. When the CPU 101 completes the data access at S310 or S311, the CPU 101 notifies the hold release signal to the DMA controller 106, and the DMA controller 106 starts the DMA transfer control again (S313).

Incidentally, when the data are read from the main memory 104 according to the data access from the CPU 101, the area where the data are written in the main memory changes, so that the address A4 in the main memory 104 in FIG. 5 is changed. In addition, when the DMA transfer is resumed and the data write to the main memory 104 is resumed, the address A1 which is the write start position has also been changed. These changed addresses A1 and A4 are controlled by the address control means 107 which is notified from the DMA controller 106 for controlling the DMA transfer.

Incidentally, with regard to the purge process of the data in the cache memory 102, if the data corresponding to the data in the main memory 104 rewritten by the DMA transfer do not exist in the cache memory 102, it is also possible to perform a switching control by the purge control means 109 so that the purge process may not be performed.

In addition, the DMA transfer process controlled by the DMA controller 106 and the memory access process by the CPU 101 are not necessarily exclusive relationship, but in a system which can simultaneously perform the DMA transfer to the main memory 104 from the I/O 105 and the data access to the main memory 104 from the CPU 101, even when the data access command from the CPU 101 is generated as described in this embodiment, while the DMA controller 106 does not interrupt the DMA transfer but continues the DMA transfer, the CPU 101 can perform the data access to the main memory 104.

In addition, for the data which have been transferred to the main memory 104 by the DMA transfer but already accessed from the CPU 101, and an address in which the data judged to be unnecessary are written, data can be overwritten by the DMA transfer. In other words, the capacity of the main memory 104 at S304 will indicate portions other than the capacity where the data which cannot be overwritten occupies.

According to this embodiment, while the purge process of the data in the cache memory has conventionally been performed for every DMA transfer data unit, the purge process of the data in the cache memory is performed according to the read request generation from the CPU, thereby making it possible to reduce the number of processes of the purge process. For example, in a system where the DMA transfer data unit is one byte, although the data in the cache memory have conventionally been purged per one byte, if a frequency of the data access generation from the CPU is one time in about 10 bytes of the amount of data of the DMA transfer while the DMA transfer is performed according to the present invention, the purge process can be reduced to 1/10.

### Fifth Embodiment

Next, description will be made of a fifth embodiment of present invention. The cache memory systems described from the first to fourth embodiments are available to various devices. For example, the cache memory system of the present invention can be introduced to a digital broadcasting receiver in a digital TV. Hereinafter, description will be made of a control method of the present invention in the digital broadcasting receiver as the fifth embodiment.

In a digital broadcasting, data required for a data broadcasting, EPG (electronic program guide) or the like are transmitted based on a data structure called a section of a transport stream such as an MPEG 2-system transport stream. A process for extracting a section from a received transport stream, and storing the same in a buffer is performed in the digital broadcasting receiver.

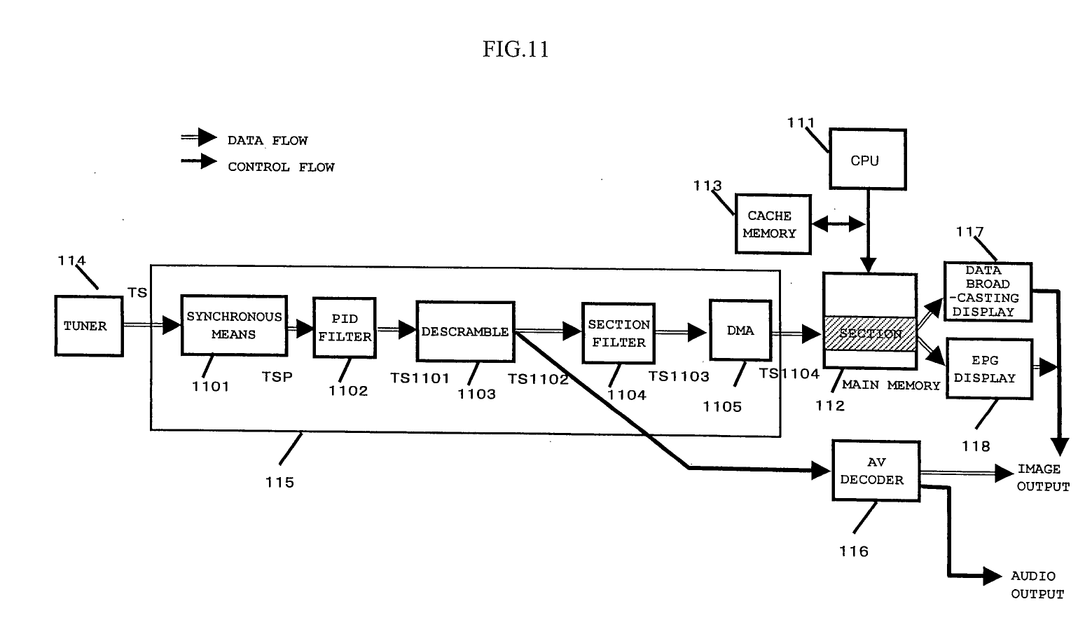

FIG. 11 is a block diagram briefly showing a configuration of the digital broadcasting receiver. Double arrows indicate a flow of data. Reference numeral 111 represents a CPU; reference numeral 112, a cache memory; reference numeral 113, a main memory accessible the CPU; and reference numeral 114, a tuner, which performs a frequency selection to find an target carrier among received electric waves, and further performs demodulation and an error correction. Selecting one TS from the carrier through supplying the same are performed. Reference numeral 115 represents a transport stream separator, and comprises synchronous means 1101, a PID filter 1102, a descrambler 1103, a section filter 1104, and a DMA 1105. The synchronous means 1101 detects starting data from a supplied TS, and extracts and supplies TSP. The PID filter 1102 supplies only required TSP based on PID of TSP supplied from the synchronous means 1101, and abandons unrequired TSP. The descrambler 1103 releases a scramble (descramble) on the data if the TSP supplied from the PID filter 1102 has been scrambled, and then supplies the same as TS1102. When the data has not been scrambled, it supplies as TS1102 as it has been. The section filter 1104 takes out a section among supplied TSP, filters to a header portion of the section, supplies only a required section as TS1103, and abandon an unrequited section. Reference numeral 1105 represents a DMA, which buffers section data in a memory 112.

Reference numeral 116 represents an AV decoder, which performs a PES complex process of a video and an audio supplied from the transport stream separator 115 to supply as a video. Reference numeral 117 represents a data broadcasting display, which supplies a data broadcasting using the section data buffered in the memory 112. Reference numeral 117 is an EPG display, which supplies EPG using the section data buffered in the memory 112.

In this embodiment, referring to the first through fourth embodiments, description will be made of a case where the DMA transfer is performed to data which are separated into a certain size with variable length and is considered as a group, such as a buffering process of this section.

For example, in the control methods of the first and third embodiments, when the data is written in the main memory 104 by the DMA transfer at S202 of the control flow chart shown in FIG. 2, the data which form the section is written in the main memory 104. In addition, the data access by the CPU 101 at S209 is performed per section. In addition, the arbitrary threshold value set to the amount of data written in the main memory by the purge control means 109 can be set as one section. In other words, the arbitrary threshold value is set as one section, so that whenever the data written in the main memory 104 by the DMA transfer at S211 reach one section, the data in the cache memory 102 corresponding to the data of one section in the main memory 104 can be purged. In addition, it is also possible to set the threshold value as not only a size of one section but also a size of several arbitrary sections. In that case, the data in the cache memory 102 corresponding to a plurality of sections written in the main memory 104 by the DMA transfer can be purged collectively, thereby further reducing the purge process. In addition, at S208 in FIG. 2, a comparison between the size of the section written in the main memory 104 by the DMA transfer and the set threshold value will be performed. In addition, it is also possible to control the data access command from the CPU 101 at S206 in FIG. 2 to be generated when one section has been transferred to the main memory 104. In that case, the amount of data of the one section is compared with the set arbitrary threshold value at S208, and it is possible to set so as to proceed to S209, or S210, if it is not more than the threshold value, or not less than the threshold value, respectively. In addition, at S211 in FIG. 2, when the threshold value is set as the last address of the main memory, there may be a case where the section written in the main memory reaches the last address of the main memory, and is then written from the starting address of the main memory. In this case, the data in the cache memory corresponding to a data portion written from the starting address is also purged.

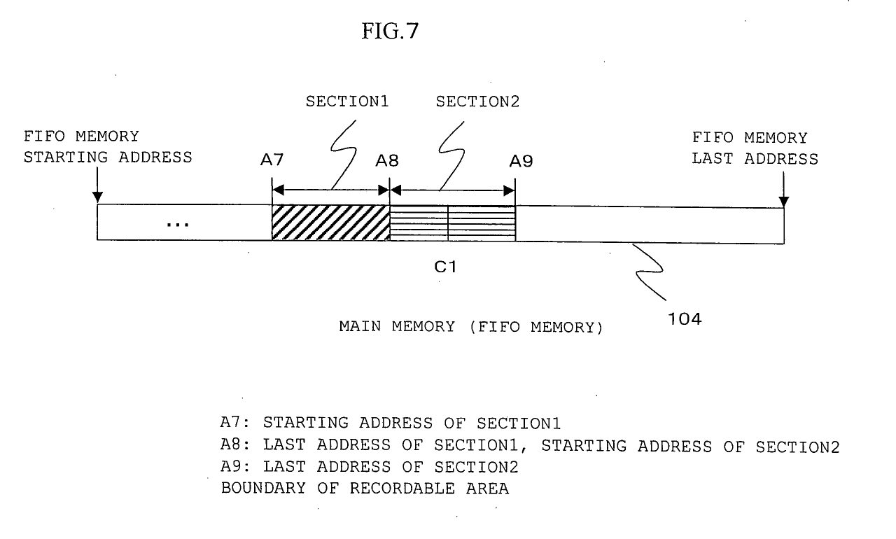

In addition, for example in the control methods in the second and fourth embodiments, when the data is written in the main memory 104 by the DMA transfer at S302 of the control flow chart shown in FIG. 3, the data which have formed the section are written in the main memory. In addition, in a process which judges whether or not the amount of data transferred to the main memory 104 by the DMA transfer at S304 reaches the writable capacity of the main memory 104, as shown in FIG. 7 representing the address state of the main memory 104, although when an address Cl is set as a boundary of a recordable area, the data can be written up to a section 1, since an address A8 is not more than the address C1, when a section 2 is written in the main memory 104, an address A9 indicating a data position after the write operation will exceed the threshold value address Cl, so that it can not be written therein. In view of such a situation, the DMA controller 106 controls the amount of data of section data transferred by the DMA transfer; when the section 2 which exceeds the writable capacity of the main memory 104 by being written in the main memory 104 is written in the main memory 104 by the DMA transfer, judges that the amount of write data in the main memory 104 will exceed the writable capacity of the main memory 104 in advance; and performs the purge process of the data in the cache memory 102 corresponding to the data written in the main memory 104 by the DMA transfer at S305, the DMA transfer completion process at S306 without performing the purge process at S305, the data read request to the CPU 101, or the like.

According to the present invention having such characteristics, the method of a purge process required at the time of a section buffering is switched according to situations, thereby making it possible to reduce a purge time which has formerly been required. Thus, the processing time of the section buffering may be reduced, so that the digital broadcasting receiving system which can display EPG and data broadcasting at high speed can be configured.

Incidentally, in this embodiment, although description has been made of the data processing per section taking a MPEG 2-system transport stream as an example, an available application of the control method of this embodiment is not limited to this, and it may be available when managing the data where the data group such as section does make sense.

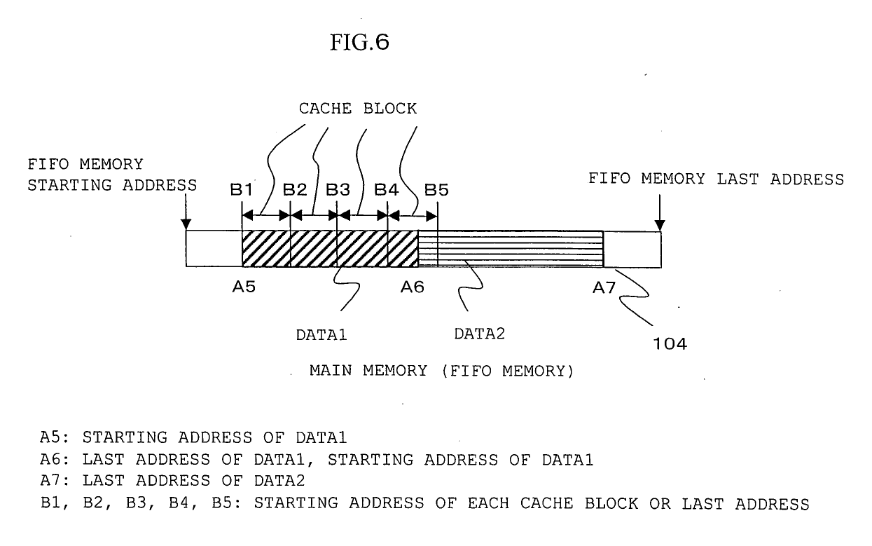

Incidentally, in the first through fifth embodiments described above, description will be made a case where the access from the CPU 101 is performed per predetermined block called cache block to the data written in the main memory 104 using the address state in the main memory shown in FIG. 6.

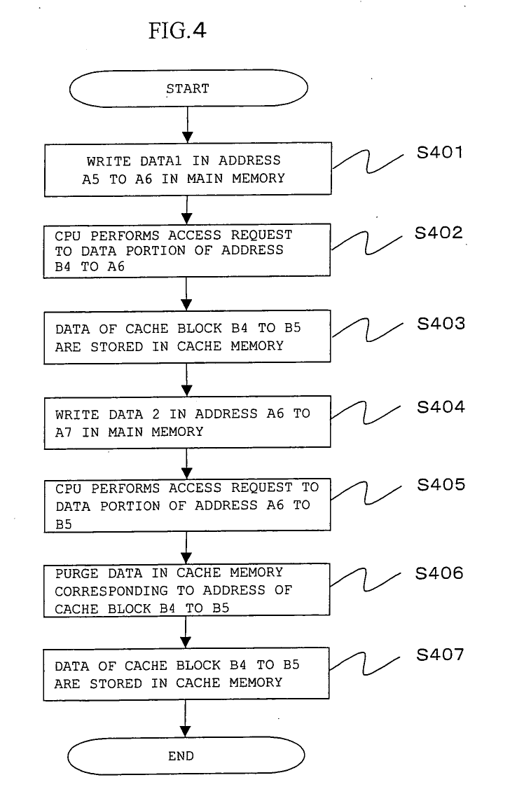

Generally, when the CPU 101 accesses the data in the main memory 104, the access operation is performed per block with predetermined width called the cache block, and an accessed cache block is stored in the cache memory 102. For example, in FIG. 6, when accessing a whole data 1 currently recorded in an address A5 to an address A6, four cache blocks of cache block B1 to B2, B2 to B3, B3 to B4, and B4 to B5 will be accessed. At this time, data of the cache blocks B1 to B2, B2 to B3, B3 to B4, and B4 to B5 are stored in the cache memory. In addition, for example when accessing data of a portion between the address B4 and the address A6 of the data 1, the cache block B4 to B5 is accessed. In addition, the data of the cache block B4 to B5 are then stored in the cache memory 102. Hereinafter, using the flow chart in FIG. 4, and the main memory 104 in FIG. 6, description will be made of an operation when the access request is generated from the CPU 101 to a data portion of an area of the address B4 to the address A5 of the data 1 in the main memory 104; and an operation when the data 2 are further written in the address A6 to the address A7 next to the data 1 thereafter, and the access request is generated from the CPU to a data portion of an area of the address A6 to B5 of the data 2 included in the cache block B4 to B5.

First, the data 1 are written in the address A5 to the address A6 in the main memory by the DMA transfer (S401). Next, the access request is generated by the CPU 101 to the address B1 to the address A6 of the data 1 (S402). The CPU 101 then reads the data of the cache block B1 to B5 from the main memory 104, and the data of the cache block B1 to B5 are stored in the cache memory 102 (S403). Next, the data 2 are written in the address A6 to A7 in the main memory 104 by the DMA transfer (S404) . After the data 2 are written in the main memory 104, the CPU 101 generates the access request to the data portion of the address A6 to B5 of the data 2 (S405). Consequently, an inconsistency between the data of the address A6 to B5 in the main memory 104 stored in the cache memory 102 at the process of S403, and the data of the address A6 to B5 in the main memory 104 rewritten at a process of S404 has arisen, so that in order to prevent this inconsistency, the data in the cache memory 102 corresponding to the cache block B4 to B5 of the main memory 104 are purged (S406). The CPU 101 then reads the data of the cache block B4 to B5 from the main memory 104, and the data of the cache block B4 to B5 are newly stored in the cache memory 102 (S407). Incidentally, in a state where the data written in the address B4 to A6 of the main memory 104 before the data 1 are written in the cache memory 102 by the DMA transfer are stored in the cache memory 102, when the data access request to the data of the address B4 to A6 in the main memory 104 is generated by the CPU 101 at S402, before the CPU 101 reads the cache block B4 to B5 at S403, and performs the process for storing the data of the cache block B4 to B5 in the cache memory 102, the data in the cache memory 102 corresponding to the cache block B4 to B5 of the main memory 104 are purged. In addition, even in a case where the data 1 and the data 2 are not adjacent to each other, if the data 1 and the data 2 have a data portion included in an area of one cache block, the above process is available.

According to the above process, when a part in the data which is to be a target for read from the CPU shares the cache block with the data which have already been read, the purge process is performed to the data stored in the cache memory corresponding to the area of the shared cache block, so that also when the CPU reads the data per cache block, an inconsistency between the data in the main memory and the data in the cache memory corresponding to the address of that data can be prevented.

Incidentally, the above process is available not only when the data 1 and the data 2 are adjacent to each other, but also when the part of the data 1 and the data 2 shares the cache memory. In other words, when the main memory is a memory such as the FIFO memory of the ring buffer, the data 1 and the data 2 are adjacently written as shown in FIG. 6, so that the control shown in the flow chart in FIG. 4 is available; and even when the main memory is a memory other than that, when the data 1 and the data 2 are adjacently written, or when the data 1 and the data 2 are not adjacent to each other, but the parts of each of them shares the cache block, the control shown in the flow chart in FIG. 4 is available.

In addition, in the discussion of the above first through fifth embodiments, although description has been made an example where the data access by the CPU and the DMA transfer control of the DMA controller have been independently performed, these may also be controlled mutually. Specifically, in storing the data in the main memory by the DMA transfer, by instructing the DMA controller to transfer only what the CPU requires by the DMA transfer, it is possible to control so that the amount of data transferred by the DMA transfer may not exceed the writable capacity of the main memory. Alternatively, it may also be possible that the read control of the CPU is performed when the data written in the main memory by the DMA transfer reach the writable capacity to the main memory. By employing such control methods, that makes it possible that for example, the process such as S304 in FIG. 3 which is the control flow chart of the second and third embodiments may be eliminated, and the process of S304, and the process of S307 are made into one timing, so that the cache memory system of the present invention may operate at high speed with fewer process steps.

In addition, the configuration of the cache memory of the present invention used in the above first through fifth embodiments is not necessarily limited to the configuration shown in FIG. 1, but the purge means, the address control means, the purge control means, and the like may also be integrated as one controller, and these means may also be included as a function of apart of the DMA controller or the CPU. In addition, although description has been made such that the data transferred to the main memory by the DMA transfer have been transferred from the external sources via the I/O, the data may be transferred from other memory or the like without passing through the I/O.

1. A memory system control method in a system which comprises a central processing unit, a cache memory, and a main memory, and has a DMA transfer function to said main memory, characterized in that
when the amount of data transferred to said main memory reaches an arbitrary value, data in said cache memory corresponding to an address of the data in said main memory which have been written by a DMA transfer are purged.

2. A control method according to claim 1, wherein the memory system control method is characterized in that
when an access request is made by said central processing unit to the data in said main memory which have been written by the DMA transfer before the amount of data transferred to said main memory reaches an arbitrary value, the data in said cache memory corresponding to the address of the data in said main memory which have been written by said DMA transfer are purged.

3. A control method according to claim 1, wherein the memory system control method is characterized in that
when all data that are to be written in said main memory by said DMA transfer are transferred before the amount of data transferred to said main memory reaches an arbitrary value, all data in said cache memory corresponding to the address of the data in said main memory which have been written by the DMA transfer are purged.

4. A control method according to claim 2, wherein the memory system control method is characterized in that
when all data that are to be written in said main memory by the DMA transfer are transferred, before the amount of data transferred to said main memory reaches an arbitrary value and before an access request is made by said central processing unit to the data in said main memory which have been written by the DMA transfer, all data in said cache memory corresponding to the address of the data in said main memory which have been written by the DMA transfer are purged.

5. A memory system control method in a system which comprises a central processing unit, a cache memory, and a main memory, and has a DMA transfer function to said main memory, characterized in that
when an access request is made by said central processing unit to the data in said main memory which have been written by the DMA transfer, data in said cache memory corresponding to the address of the data in said main memory which have been written by the DMA transfer are purged.

6. A control method according to claim 5, wherein the memory system control method is characterized in that
when an access request is made by said central processing unit to the data in said main memory which have been written by the DMA transfer, if the amount of data in said main memory which have been written by the DMA transfer is not more than an arbitrary value, the data in said cache memory is not purged, and said central processing unit reads the data in said main memory which have been written by the DMA transfer without using said cache memory.

7. A memory system control method in a system which comprises a central processing unit, a cache memory, and a main memory, and has a DMA transfer function to said main memory, characterized in that
when an access request is made by said central processing unit to the data in said main memory which have been written by the DMA transfer, data in said cache memory corresponding to the address of the data in the main memory to which an access request is made from said central processing unit are purged.

8. A memory system control method in a system which comprises a central processing unit, a cache memory, and a main memory, and has a DMA transfer function to said main memory, characterized in that
when the amount of data transferred to said main memory reaches an available recording capacity of said main memory, the DMA transfer is stopped.

9. A memory system control method in a system which comprises a central processing unit, a cache memory, and a main memory, and has a DMA transfer function to said main memory, characterized in that
when the amount of data transferred to said main memory by the DMA transfer reaches an available recording capacity of said main memory, data in said cache memory corresponding to the address of the data in said main memory which have been written by the DMA transfer are purged.

10. A control method according to claim 9, wherein the memory system control method is characterized in that
the data in said cache memory corresponding to the address of the data in said main memory which have been written by the DMA transfer are purged, and said central processing unit reads the data in said main memory which have been written by the DMA transfer.

11. A memory system control method according to claim 10, wherein the memory system control method is characterized in that
if the amount of data in said main memory which have been written by DMA transfer is not more than an arbitrary value, the data in said cache memory are not purged, and said central processing unit reads the data in said main memory which have been written by the DMA transfer without using said cache memory.

12. A memory system control method according to claim 1, characterized in that said main memory is a FIFO memory of a ring buffer.

13. A memory system control method according to claim 1, characterized in that
said main memory is the FIFO memory of the ring buffer, and a case where the amount of data transferred to said main memory by the DMA transfer reaches said arbitrary threshold value is a case where a data writing location to said main memory reaches a last address of said main memory.

14. A memory system control method according to claim 1, characterized in that
said main memory is the FIFO memory of the ring buffer, and a case where the amount of data transferred to said main memory by the DMA transfer reaches said arbitrary threshold value is a case where the data writing location to said main memory moves to a starting address from the last address of said main memory.

15. A memory system control method according to claim 1, characterized in that
said main memory is the FIFO memory of the ring buffer, and a case where the amount of data transferred to said main memory by the DMA transfer reaches said arbitrary threshold value is a case where a data writing location to said main memory reaches a starting address of data which has been recorded in said main memory and not been read therefrom.

16. A memory system control method according to claim 1, characterized in that
said main memory is the FIFO memory of the ring buffer, and a case where the amount of data transferred to said main memory by the DMA transfer reaches said arbitrary threshold value is a case where a data writing location to said main memory reaches a data writing starting address to said main memory by the DMA transfer.

17. A memory system control method according to claim 8, characterized in that
said main memory is the FIFO memory of the ring buffer, and a case where the amount of data transferred to said main memory by the DMA transfer reaches the available recording capacity of said main memory is a case where the data transferred to said main memory reaches a starting address of the data currently written in said main memory.

18. A memory system control method according to claim 1, characterized in that
the data transferred to said main memory by the DMA transfer is comprised of one data group or a plurality of data groups.

19. A memory system control method according to claim 1, characterized in that
the data transferred to said main memory by the DMA transfer is comprised of one data group or a plurality of data groups, and said arbitrary value is the amount of data of said data groups.

20. A memory system control method according to claim 1, characterized in that
the data transferred to said main memory by the DMA transfer is comprised of one data group or a plurality of data groups, and said arbitrary value is the amount of data of the arbitrary number of said data groups.

21. A memory system control method according to claim 1, characterized in that
the data transferred to said main memory by the DMA transfer has a section format.

22. A memory system control method according to claim 1, characterized in that
the data transferred to said main memory by the DMA transfer has the section format, and said arbitrary value is the amount of data of one section.

23. A memory system control method according to claim 1, characterized in that
the data transferred to said main memory by the DMA transfer has the section format, and said arbitrary value is the amount of data of the number of arbitrary sections.

24. A memory system control method according to claim 2, characterized in that
said central processing unit reads one block or a plurality of blocks with a predetermined address width including data in said main memory to which the access request is made, and before said central processing unit reads said one block or said plurality of blocks, data in the cache memory corresponding to an area of said one block or said plurality of blocks are purged.

25. A memory system control method in a system which comprises a central processing unit, a cache memory, and a main memory, and has a DMA transfer function to said main memory, wherein said central processing unit performs data read per predetermined block to said main memory, characterized by comprising the steps of:
requesting an access for said central processing unit to make an access request to data written in said main memory by a DMA transfer,
purging for purging all data in said cache memory corresponding to an area of said predetermined block including the data in said main memory to which the access request is made by said central processing unit, and
reading for said central processing unit to read all data in the area of said predetermined block including said first data in said main memory.

26. A memory system control method in a system which comprises a central processing unit, a cache memory, and a main memory, and has a DMA transfer function to said main memory, wherein said central processing unit performs data read per predetermined block to said main memory, characterized by comprising the steps of:
a first read for said central processing unit to read data in one block or a plurality of blocks including a first data currently recorded in said main memory,
a storage for storing said first data in said cache memory,
a write for writing a second data in said main memory by a DMA transfer after said storing step, and a second read for said central processing unit to read said second data in one block or a plurality of blocks therefrom,
wherein when there exists a block including a part or all of said first data in said one block or said plurality of blocks in said second read, all addresses in said cache memory corresponding to the block in said main memory which has been read in said second read step are purged.

27. A memory system control method according to claim 24, wherein said block is a cache block.
